(19) United States
(12) Patent Application Publication
(10) Pub. No.: US 2009/0110405 A1
(43) Pub. Date: Apr. 30, 2009

(54) METHOD OF COMMUNICATING BETWEEN TERMINALS USING OPTICAL WIRELESS LINE AND MOBILE TERMINAL FOR PERFORMING THE SAME

(76) Inventors: Kyung Woo LEE, Yongin-si (KR); Dae Kwang Jung, Suwon-si (KR); Jeong Seok Choi, Yongin-si (KR); Hong Seok Shin, Suwon-si (KR); Dong Jae Shin, Seoul (KR); Sung Bum Park, Suwon-si (KR)

Correspondence Address: CHA & REITER, LLC, 210 ROUTE 4 EAST STE 103, PARAMUS, NJ, 07652, US

(21) Appl. No.: 12/256,552

(22) Filed: Oct. 23, 2008

(30) Foreign Application Priority Data
Oct. 29, 2007 (KR) 2007-0108690

(51) Int. Cl. H04B 10/00

(52) U.S. Cl. 398/130

(57) ABSTRACT

A wireless communication method between mobile terminals using visible light and a mobile terminal therefore are disclosed. The method includes: periodically transmitting device discovery signals for searching for a visible light communication device when there is a request for a visible light communication; transmitting only reference clock signals between the device discovery signals; and connecting a link to a receiving terminal to transmit data when a response signal for the device discovery signal is received from the receiving terminal.

### CLAIMS OF PRIORITY

This application claims priority to an application entitled “METHOD OF COMMUNICATING BETWEEN TERMINAL USING OPTICAL WIRELESS LINE AND MOBILE TERMINAL FOR PERFORMING THE SAME.” filed in the Korean Intellectual Property Office on Oct. 29, 2007 and assigned Serial No. 2007-0108690, the entire contents of which are incorporated herein by reference.

### BACKGROUND OF THE INVENTION

1. Field of the Invention

The present invention relates generally to wireless communication between mobile terminals and, more particularly, to a method of performing optical communication using visible light and a mobile terminal for performing the same.

2. Description of the Related Art

There are many efforts for providing various services to the growing number of users of mobile terminals with a radio frequency (hereinafter, refers to ‘RF’) such as different frequencies and broadband with various wireless communication technologies in various countries and local areas for the communication between mobile terminals. However, there is a limit for providing these services with RF broadband. Due to this limit, there are rising issues such as exhaustion of RF broadband frequencies, possibility of crossed lines of several wireless communication technologies, increase of demands for security of the communication, and an arrival of high speed ubiquitous communication circumstance of 4th-generation wireless communication technology. Interest in a complementary technology of RF technology is increasing in order to solve the rising issues. The complementary technology is a communication method using electromagnetic waves. Light, that is, electromagnetic waves are classified into ultraviolet rays (UV), visible light, and infrared rays (IR) according wavelength. Ultraviolet rays have a wavelength of 10 angstrom to 400 nm and a frequency of 30 PHz to 0.75 PHz, visible light has a wavelength of 400 nm to 750 nm and a frequency of 750 THz to 400 THz, and infrared rays have a wavelength of 750 nm to 1,000 micrometers and a frequency of 400 THz to 0.3 THz. As described above, frequency resource used in the optical wireless communication is 0.3 THz to 750 THz and is almost infinite in comparison to the frequency resource used in RF communication.

Among the infrared rays, near-IR (NIR), that is, a broadband of 400 THz to 100 THz, is a frequency broadband used in current optical communication. Research is being conducted to enable peer-to-peer communication between mobile terminals using the NIR frequencies by which infrared data association (IrDA) modules are installed in portable devices such as a mobile phone, a personal digital assistant (PDA), and the like, and small-sized appliances such as a digital camera, a moving picture experts group-1 audio layer 3 (MP3) player, and the like, and developments regarding a product performing the peer-to-peer communication are being achieved and commercialized. Wireless communication using electromagnetic waves has no crossed line between terminals, an excellent communication security, and can be implemented with a low electric power differently from the wireless communication using RF such as Bluetooth, Zigbee, and the like.

FIG. 1 is a view illustrating a layered architecture for performing wireless communication using infrared rays.

Referring to FIG. 1, a sending terminal 101 and a receiving terminal 102 respectively include a transmitter/receiver (TRx) 110 and 120 for transmitting and receiving a signal through infrared rays, and an encoder/decoder 112 and 122 positioned above the transmitter/receiver to encode and decode the transmitted and received signal. Above the encoder/decoder 112 and 122 are positioned IrDA Link access protocols 114 and 124 (hereinafter, referred to ‘IrLAP’) which are data link layers in charge of link access in an IrDA structure. Above, the IrLAPs 114 and 124 are positioned upper layers 116 and 126 like application layers. When the sending terminal 101 requests the communication using infrared rays through the layered architecture, the sending terminal 101 is connected to the receiving terminal 102 for the infrared communication therebetween by which the sending terminal transmits a request signal through infrared rays and the receiving terminal 102 receives the transmitted signal. The signal transmitted and received between the sending terminal 101 and the receiving terminal 102 will be described with reference to FIG. 2.

FIG. 2 is a view illustrating an example of the signal transmitted for the infrared communication between the terminals.

Referring to FIG. 2, the sending terminal 101 periodically transmits a device discovery signal 202 for the request of the infrared communication. The device discovery signal 202 is transmitted until a response signal is received for the device discovery signal from the receiving terminal 102. When the sending terminal 101 receives a discovery response signal 212 as the response signal from the receiving terminal 102, the sending terminal 101 transmits a link negotiation signal 204 for the link access. When the sending terminal 101 receives a negotiation response signal 214 from the receiving terminal 102, the sending terminal 101 transmits data 206 to perform the communication with the receiving terminal 102. When the receiving terminal 102 receives data transmitted from the sending terminal 101, the receiving terminal 102 transmits a data acknowledge signal 216 to the sending terminal 101 every preset time or every data frame to report the receiving status of data. When the sending terminal 101 does not receive a response signal for the preset time or the data frame, the sending terminal 101 considers the connection with the receiving terminal 102 to be interrupted and transmits a link restoration signal 208 for re-connection. When the receiving terminal 102 enters a connection zone of the infrared rays capable of receiving a signal from the sending terminal 102 and receives the link restoration signal 208, the sending terminal 101 transmits a restoration response signal 218 as a response signal for the link restoration signal 208 to the receiving terminal 102. Since the sending terminal 101 which received the restoration response signal 218 is connected to the receiving terminal 102 again, the sending terminal 101 again transmits data for a part of which a response signal was not received from the receiving terminal 102.

However, since the infrared communication cannot be checked with a naked eye, it is inconvenient to connect terminals. In other words, since the infrared communication cannot be checked with a naked eye, it is inconvenient to periodically transmit a signal to search for a device. Moreover, since the infrared rays must be radiated over a wide divergence angle of about 30 degrees such that a user aligns respective terminals with each other, it is not effective.

### SUMMARY OF THE INVENTION

The present invention is made in view of overcoming drawbacks of the infrared communication, and the present invention provides a communication method between a mobile terminal and an apparatus for performing the same.

The present invention also provides a communication method using visible light and an apparatus for performing the same.

In accordance with an embodiment of the present invention, a wireless optical communication method includes: periodically transmitting device discovery signals for searching for a visible light communication device when there is a request for a visible light communication; transmitting only reference clock signals between the device discovery signals; and connecting a link to a receiving terminal to transmit data when a response signal for the device discovery signal is received from the receiving terminal.

In accordance with another embodiment of the present invention, t a wireless optical communication method includes: transmitting a response signal in response to a device discovery signal of searching for a visible light communication device when the device discovery signal of searching for the visible light communication device is received; transmitting a clock signal; and receiving data by connecting a link to a sending terminal.

In accordance with another embodiment of the present invention, there is provided a mobile terminal includes: an optical transceiver to transmit and receive a signal through visible light; an encoder/decoder to encode and decode a data signal and a clock signal with differential Manchester codes; and a controller to periodically transmit device discovery signals of searching for a visible light communication device and to transmit only a reference clock signal between the device discovery signals when a visible light communication is requested, and to connect a link to a receiving terminal to transmit data when a response signal for the device discovery signals is received from the receiving terminal. Moreover, the controller, after the synchronization of the clocks, changes a duty cycle of only the reference clock signal to be transmitted every preset time until the communication with the receiving terminal is finished.

In accordance with another embodiment of the present invention, a mobile terminal includes: an optical transceiver to transmit and receive a signal through visible light; an encoder/decoder to encode and decode a data signal and a clock signal with differential Manchester codes; and a controller to periodically transmit device discovery signals of searching for a visible light communication device when the device discovery signals are received, to transmit a response signal for the device discovery signals in the form of a signal encoded with the differential Manchester codes, to periodically transmit the clock signal, and to receive data by connecting a link to a sending terminal.

### BRIEF DESCRIPTION OF THE DRAWINGS

The above features and advantages of the present invention will be more apparent from the following detailed description taken in conjunction with the accompanying drawings, in which:

FIG. 1 is a view illustrating a layered architecture for performing a wireless communication using infrared rays;

FIG. 2 is a view illustrating an example of the signal transmitted for the infrared communication between the terminals;

FIG. 3 is a view illustrating a layered architecture for visible light communication according to an embodiment of the present invention;

FIG. 4 is a view illustrating examples of signals transmitted and received for the visible light communication between mobile terminals according to an embodiment of the present invention;

FIG. 5 is a view illustrating an example of a clock signal and a data signal encoded by differential Manchester encoding to which the present invention is applied;

FIG. 6A is a view illustrating a connection between mobile terminals according to an embodiment of the present invention;

FIG. 6B is a view illustrating a recovery of a disconnected communication during the communication according to an embodiment of the present invention;

FIG. 7 is a view illustrating an example of brightness of the visible light in accordance with the alignment of mobile terminals according to an embodiment of the present invention;

FIG. 8 is a flowchart illustrating a communication performed by a sending terminal through the visible light according to an embodiment of the present invention; and

FIG. 9 is a flowchart illustrating a communication performed by a receiving terminal through the visible light according to an embodiment of the present invention.

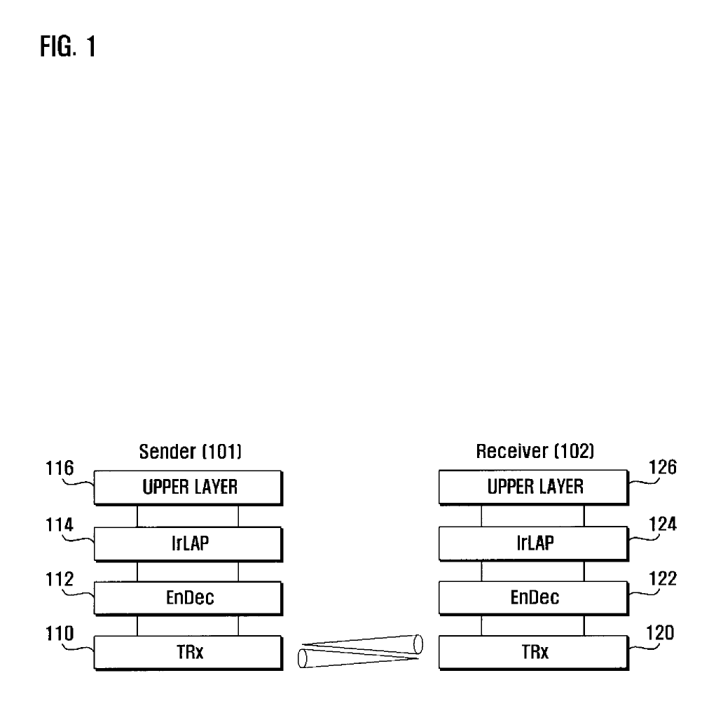

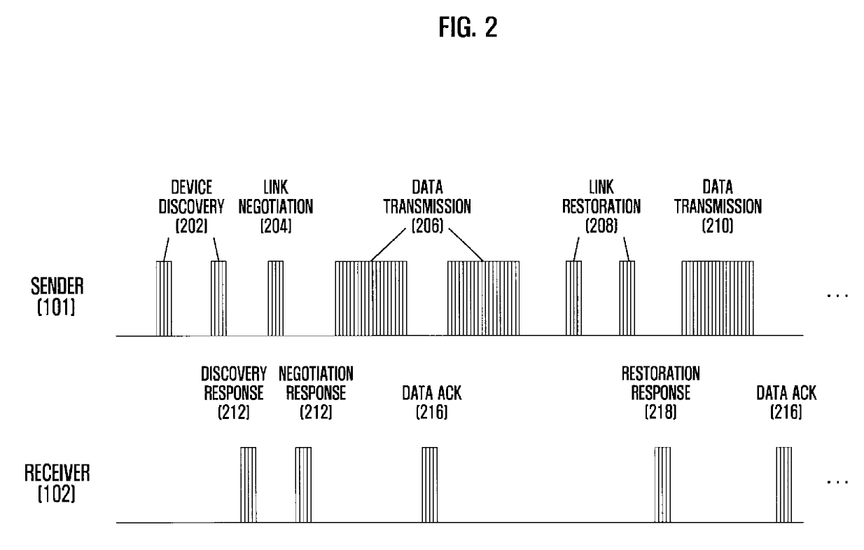

### DETAILED DESCRIPTION OF THE INVENTION

Hereinafter, embodiments of the present invention are described in detail with reference to the accompanying drawings. The same reference symbols identify the same or corresponding elements in the drawings. Detailed descriptions of constructions or processes known in the art may be omitted to avoid obscuring the invention in unnecessary detail. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as exemplary only and does not describe every possible instance of the invention. Therefore, it should be understood that various changes may be made and equivalents may be substituted for elements of the invention.

The present invention as a solution for overcoming the inefficiency of a communication using infrared rays provides a communication using visible light. Visible light is an electromagnetic wave visible with a naked eye and having a wavelength range of 400 nm to 750 nm. A light emitting diode (hereinafter, referred to as “LED”) is mostly used as a light source for emitting the visible light. The LED is a device in which minority carriers (electrons or holes) injected through a specific structure of a semiconductor are generated and light is emitted due to recombination of electrons and holes, and luminous efficiency of the LED has been improved as technology of the LIED has been developed. Moreover, in addition to the luminous efficiency, the price of the LED has fallen so that the LED has become common enough to used in a variety of lighting situations such as a mobile terminal, a display, an automobile, a traffic light, and an advertising panel, and general lighting such as a luminescent lamp, an incandescent electric lamp, and the like. Particularly, various technical aspects of the LED are rapidly developing, for example, luminous efficiency of a white LED already exceeds that of an incandescent electric lamp and products superior to an incandescent lamp are already being produced and shipped.

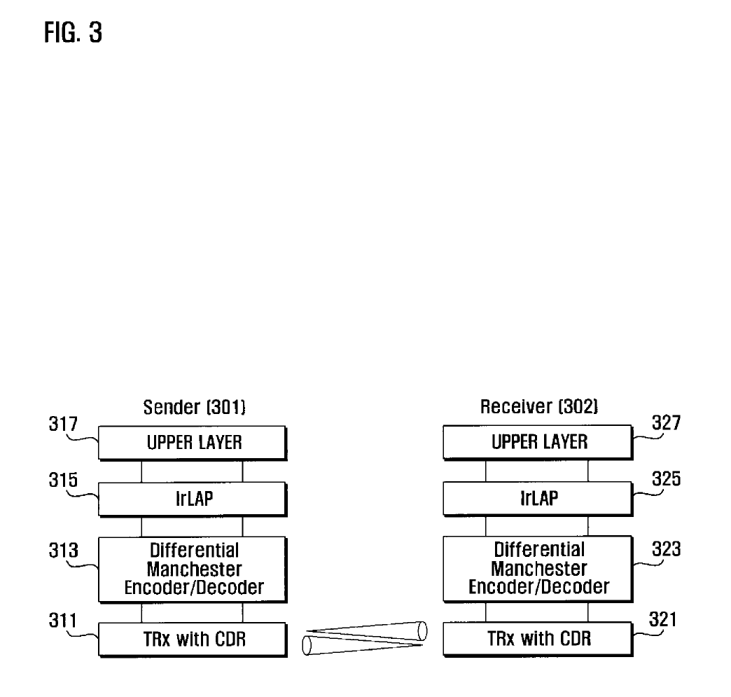

FIG. 3 is a view illustrating a layered architecture for a visible light communication according to an exemplary embodiment of the present invention.

Referring to FIG. 3, a sending terminal 301 transmits a signal to a receiving terminal 302 for the visible light communication. In this case, the signal transmitted from the sending terminal 301 is delivered to the receiving terminal 302 through an upper layer 317, an IrLAP 315, a differential Manchester encoder/decoder 313, and an optical transceiver 311. The upper layer 317 includes applications for processing data, the IrLAP 315 handles procedures of connecting links for the visible light communication, and the differential Manchester encoder/decoder 313 converts the signal transmitted to the receiving terminal by applying an exclusive-OR (XOR) operation to a data signal and a clock signal through the differential Manchester encoding/decoding. The differential Manchester encoding/decoding is a technique of encoding a signal using the differential Manchester encoding codes in which a signal is transited or not according to ‘0’ (zero) or ‘1’ (one) at an intermediate of an interval. An example in which the clock signal and the data signal are encoded by the differential Manchester encoding/decoding will be described in detail with reference to the drawings.

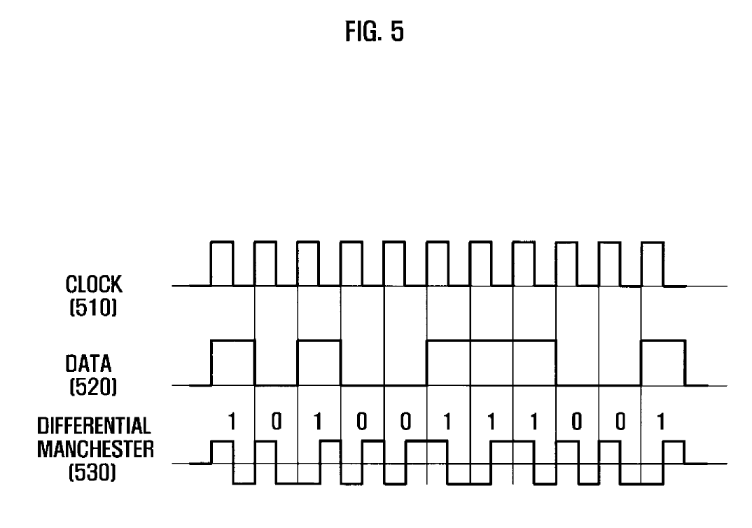

FIG. 5 is a view illustrating an example of the clock signal and the data signal encoded by the differential Manchester encoding to which the present invention is applied.

Referring to FIG. 5, if it is assumed that the clock signal 510 is a reference signal and uniformly transmitted and the data signal 520 is transmitted as ‘10100111001’, a signal encoded by the differential Manchester encoding is the same as a signal 530. In other words, a bit ‘1’ of the differential Manchester signal 530 is a state of ‘high-low’, a next bit maintains the same pattern as the previous bit when the next bit is ‘0’, and the next bit is transmitted opposite to the pattern of the previous bit when the next bit is ‘1’. Thus, the bit ‘0’, following the bit ‘1’ (high-low), is encoded into ‘high-low’, and a next bit ‘1’ following the very previous bit is transmitted and encoded into ‘low-high’. By this manner, the clock signal and the data signal are encoded by the differential Manchester encoder/decoder and are transmitted as a single combined signal, and then the combined signal of the clock signal and the data signal is decoded by the differential Manchester encoder/decoder so that the combined signal is separated into the original signals, the clock signal and the data signal. Since the clock signal and the data signal are transmitted after the combination in the present invention, it is easy to synchronize the clock. Moreover, since a ratio of ‘1’ (high) and ‘0’ (low) is maintained during the communication because of using the differential Manchester codes, brightness of a light source can be uniformly maintained. In other words, if it is assumed that the light source emits light when a signal is ‘1’ and turned off when the signal is ‘0’, since the ratio of luminescence and quenching is maintained constant, a user perceives the brightness of the light source as uniform.

Returning to FIG. 3, the encoded signal by the differential Manchester encoding is transmitted to the receiving terminal 302 through the optical transceiver 311. The optical transceiver 311 performs a wireless communication of mobile terminals and includes a transmitter unit and a receiver unit for respectively transmitting and receiving a signal using an LED to emit a visible light.

The signal transmitted from the sending terminal 301 is received through the optical transceiver 311 of the receiving terminal 302 and is delivered to the differential Manchester encoder/decoder 323 to be decoded. The IrLAP 325 of the receiving terminal 302 handles procedures of connecting links for the visible communication like the IrLAP 315 of the sending terminal. The decoded signal is delivered to the upper layer 327 to be processed.

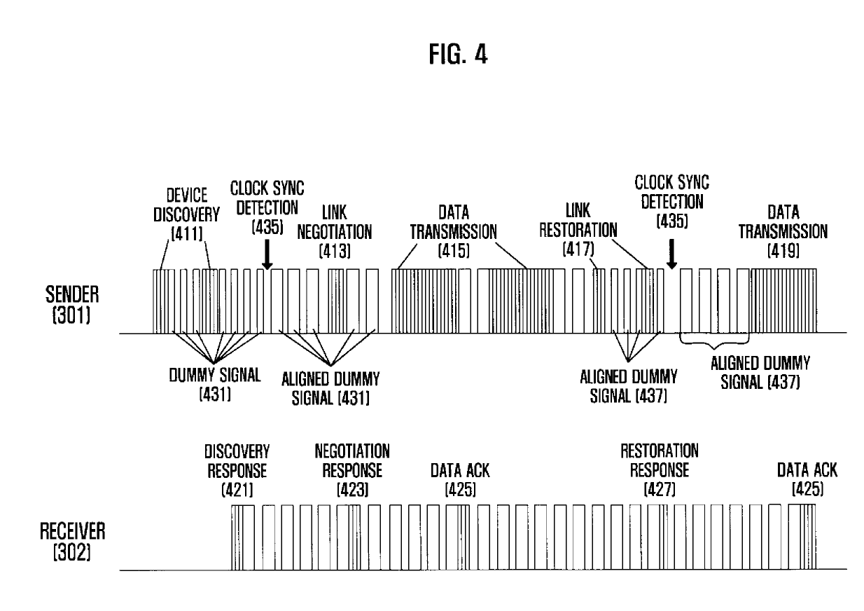

FIG. 4 is a view illustrating examples of signals transmitted and received for the visible light communication between the mobile terminals according to an exemplary embodiment of the present invention.

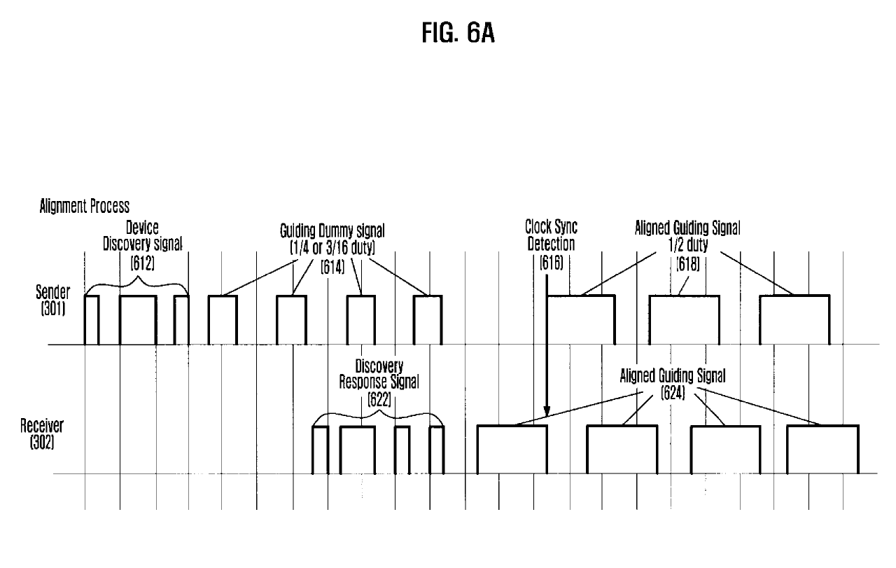

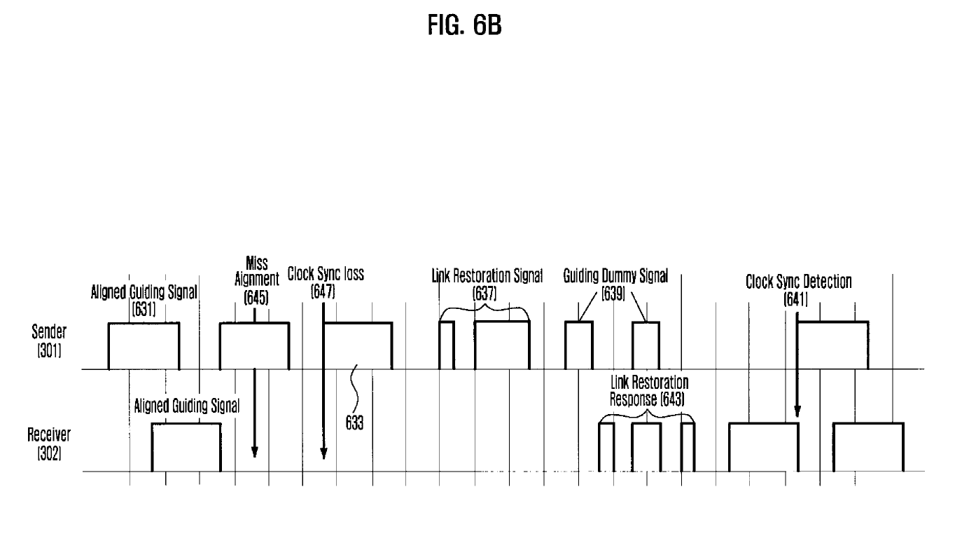

Referring to FIG. 4, the sending terminal 301 periodically transmits a device discovery signal 411 for the request of the optical communication. The device discovery signal 411 is transmitted until a response signal for the device discovery signal 411 is received from the receiving terminal 302. Here, the time period where the device discovery signal 411 is transmitted may be determined by a user or a manufacturer. The sending terminal 301 transmits a dummy signal 431 between the periodically transmitted device discovery signals 411. The dummy signal 431 is transmitted to guide the alignment of a receiving terminal performed by the user. In other words, since the visible light is radiated more frequently than the time period where the visible light is radiated while only the device discovery signal 411 is transmitted due to the transmission of the dummy signal 431, it is easy for the user to align the terminals to communicate with each other. When the sending terminal 301 is aligned with the receiving terminal 302 and receives the discovery response signal 421 as a response signal from the receiving terminal 302, the sending terminal 301 synchronizes the clock with that of the receiving terminal 302. A clock synchronizing time 435 is when the clocks of the sending terminal 301 and the receiving terminal 302 are synchronized. The sending terminal 301 periodically transmits the device discovery signal 411 and the dummy signal 431 until the clock synchronizing time 435. After the clock synchronizing time 435, the sending terminal 301 transmits a synchronized dummy signal 437 to the receiving terminal 302. The synchronized dummy signal 437 is a signal having a duty cycle different from a duty cycle of the dummy signal 431 prior to the synchronization, but its function is the same as that of the dummy signal 431. After the alignment with the receiving terminal 302, the sending terminal 301 transmits a link negotiation signal 413 for the link connection to the receiving terminal 302. When the sending terminal 301 receives a negotiation response signal 423 from the receiving terminal 302, the sending terminal 301 transmits data 415 to perform the communication with the receiving terminal 302. The receiving terminal 302 receives the data from the sending terminal 301 and transmits a data acknowledge signal 425 to the sending terminal 301 by a preset time or a regular frame so as to inform the sending terminal 301 whether the data is received or not. When the data acknowledge signal 425 is not received by the preset time or the regular frame, the sending terminal 301 considers the connection with the receiving terminal 302 to be interrupted and transmits a link restoration signal 417 for resetting the connection to the receiving terminal 302. When the connection with the receiving terminal 302 is rebuilt by doing so and the receiving terminal 302 receives the link restoration signal 417 from the sending terminal 301, the receiving terminal 302 transmits a restoration response signal 427 as a response signal for the link restoration signal 417 to the sending terminal 301. At this time, the sending terminal 301 transmits the dummy signal 432 between the link restoration signals 417 to be periodically transmitted. Moreover, the sending terminal 301 transmits the synchronized dummy signal 437 to the receiving terminal 302 after the clock synchronization 435. The sending terminal 301 which received the restoration response signal 427 considers the connection with the receiving terminal 302 to be reestablished and again transmits data for which a response signal was not received from the receiving terminal 302. The data 419 to be retransmitted is transmitted again for a part of which a response signal is not received. An operation of connecting the mobile terminals after the device discovery and synchronizing the clocks as illustrated in FIG. 4 and an operation of disconnecting the communication and recovering the connection after that will be described in detail with reference to FIGS. 6A and 6B.

FIG. 6A is a view illustrating the connection between mobile terminals according to an exemplary embodiment of the present invention, and FIG. 6B is a view illustrating the recovery of a disconnected communication during the communication, according to an exemplary embodiment of the present invention.

Referring to FIG. 6A, for the communication, a requesting terminal becomes a sending terminal 301 and a request receiving terminal becomes a receiving terminal 302. The sending terminal 301 periodically transmits a device discovery signal 612. As described with reference to FIG. 4, dummy signals 614 are transmitted between the device discovery signals to be periodically transmitted. In this case, the dummy signal 614 is not a signal in which data signals are combined but a signal having only a clock signal. In other words, as illustrated in FIG. 5, a clock signal is combined with a data signal by differential Manchester codes when the data signal is transmitted and is encoded to be transmitted. Thus, the device discovery signal (hereinafter, referred to as ‘DDS’) is transmitted together with the clock signal and the data signal. However, since the dummy signal 614 transmitted between the DDSs is a signal with a data signal 0 (zero), only the clock signal is transmitted. In this description, the dummy signal 614 is assumed to be a signal with a duty cycle of ¼ or 3/16 and will be described under this assumption. Moreover, a signal of an oscillator in a clock data recovery (hereinafter, referred to as ‘CDR’) circuit generated when the CDR circuit is not locked by a signal is used as the dummy signal 614 or the dummy signal 614 is transmitted at the same frequency as that of the signal of the oscillator. For example, when a data signal with 120 MHz is inputted, the CDR circuit transmits the clock signal and the data signal at 120 MHz, whereas when the data signal is not inputted, the clock signal and the data signal are transmitted at 50 MHz (50 MHz is used for illustrative convenience) as a reference frequency of the oscillator in the CDR circuit. The clock signal is a dummy signal enabling the user to identify a direction of the visible light emitted from the user's mobile terminal when the user's mobile terminal is directed to another terminal for the visible light communication.

The receiving terminal 302 which detected the device discovery signal 612 transmitted from the sending terminal 301 transmits a discovery response signal 622 as a response to the device discovery signal 612 to the sending terminal 301. The sending terminal 301 synchronizes the clock using the CDR circuit of the sending terminal 301 after the reception of the device discovery response signal 622. The synchronized dummy signal 618 substitutes the dummy signal prior to the synchronization to be transmitted and the frequency of the synchronized dummy signal is different from that of the dummy signal prior to the synchronization so that brightness of the visible light is changed. Thus, the user visually detects the changed visible light and identifies that the sending terminal 301 is connected to, that is, is synchronized with the receiving terminal 302. As such, the case in which the sending terminal 301 is directed to and connected to the receiving terminal 302 for the connection is called an alignment. After the synchronization of the clocks of the sending terminal 301 and the receiving terminal 302 with each other, when links of the sending terminal 301 and the receiving terminal 302 are connected to each other and a channel is established, the link negotiation is performed by the IrLAP or other protocol and data is transmitted.

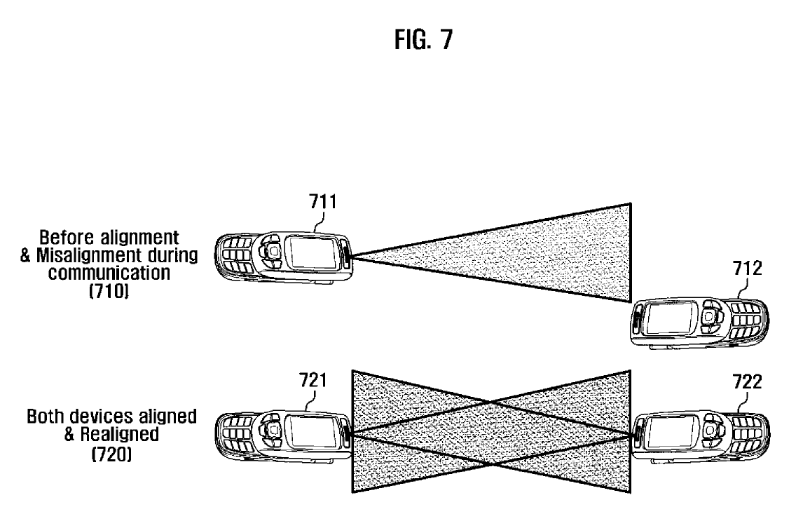

When the alignment is dropped out and becomes a misalignment 645 during the communication, the sending terminal 301 cannot receive a signal to be synchronized with a signal 633 from the receiving terminal 302. The sending terminal 301 considers the connection to the receiving terminal 302 to be interrupted and periodically transmits a link restoration signal 637 to the receiving terminal 302. As described above, dummy signals 639 are transmitted between the link restoration signals 637 transmitted from the sending terminal 301, like between the DDSs. When a link restoration response signal 543 is received from the receiving terminal 302, the CDR circuit of the sending terminal 301 synchronizes with the receiving terminal 302 at a clock synchronizing time point 641. The clock synchronizing time point 641 can be changeable by a setting such as being an end of a signal transmitted from the receiving terminal 302 or a beginning of the signal transmitted from the receiving terminal 302. When the clocks of the sending terminal 301 and the receiving terminal 302 are synchronized with each other, since a frequency of the synchronized signal is different from that of the dummy signal, that is, a previous signal prior to the synchronization, brightness of the visible light is changed. Thus, the user visually detects the changed visible light so that he/she can identify that the sending terminal 301 is aligned with the receiving terminal 302. Variation of the brightness of the visible light is depicted in FIG. 7 according to the alignment and the misalignment.

FIG. 7 is a view illustrating brightness of the visible light in accordance with the alignment of mobile terminals according to an exemplary embodiment of the present invention.

Referring to FIG. 7, a reference numeral 710 is assigned to an example of the brightness of the visible light emitted at a status before the mobile terminals are aligned with each other and a reference numeral 720 is assigned to a status where the mobile terminals are aligned with each other during the communication. In the status prior to the synchronization, since a sending terminal 711 periodically transmits a device discovery signal and the dummy signal, that is, the clock signal is transmitted between the transmission of the device discovery signal, the visible light is not bright as indicated by the reference numeral 710. Moreover, even at the misalignment during the communication, since the sending terminal 711 periodically transmits the link restoration signal and transmits the dummy signal between the transmissions of the link restoration signals, the visible light is not bright as indicated by the reference numeral 710. In other words, before the alignment and in the status of misalignment, since a pulse duration of the clock is shorter than that of the synchronized dummy signal 437 (for example, ½ duty cycle) as the case of the dummy signal 431 (for example, ¼ or 3/16 duty cycle) of FIG. 4, the visible light is not bright. For example, since the connection is interrupted during the communication in the misalignment, the pulse duration of the clock becomes short and brightness of the visible light gets dim. Thus, the user visually recognizes the change of the brightness of the visible light so that he/she understands that the terminals are misaligned during the communication.

A reference numeral 720 shows the brightness of the visible light emitted when the terminals are aligned with each other. In this case, the alignment includes a case where a sending terminal is synchronized and communicating with a receiving terminal 722 after the device discovery, and a case of a realignment where the connection is interrupted and is reestablished. Since the sending terminal and the receiving terminal are connected to transmit and receive data, a signal is transmitted at a frequency different from that of a dummy signal so that the visible light is bright as indicated by the reference numeral 720. Although it has been described with reference to FIG. 7 that the difference between the alignment and the misalignment can be identified by whether the brightness of the visible light increases or not, the difference can be also identified by changing not the brightness of, but a color of, the visible light.

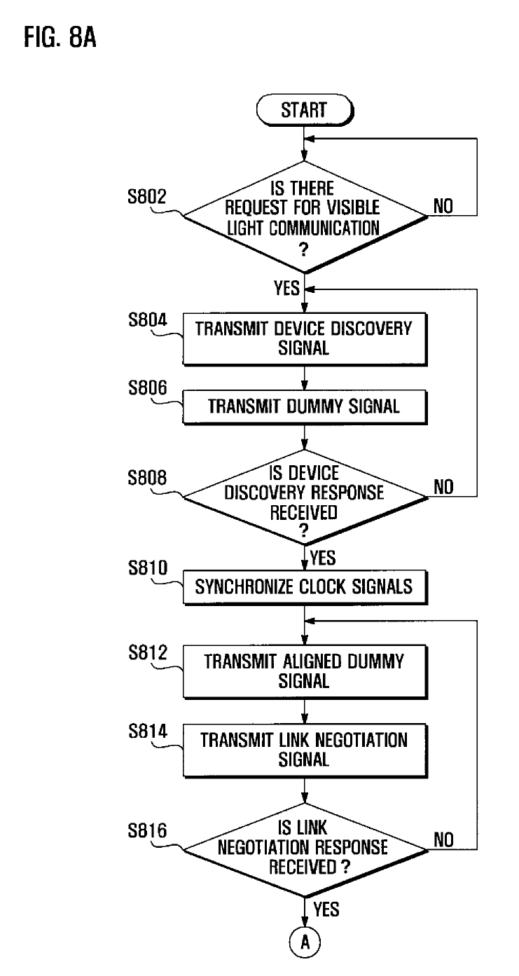

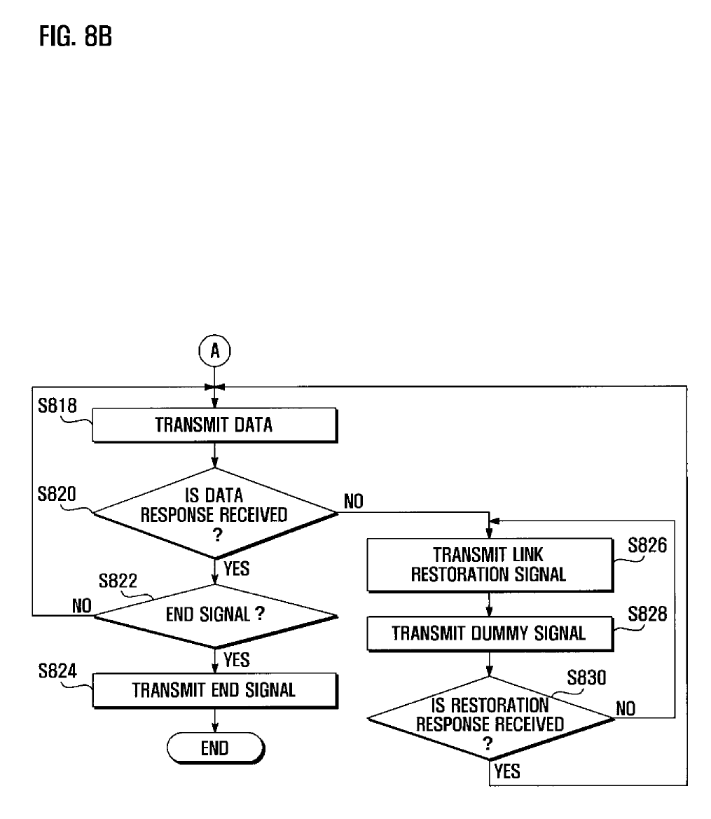

FIGS. 8A-B is a flowchart illustrating a communication performed by a sending terminal through the visible light according to an exemplary embodiment of the present invention.

Referring to FIGS. 8A-B, a controller (not shown) of the sending terminal 301 of FIG. 3 checks whether the user requests the visible light communication (S802). The controller controls overall operations of the mobile terminal and overall procedures of the visible light communication carried out through the layers shown in FIG. 3 are performed by the controller. The controller transmits the device discovery signal in order to search for a receiving terminal for the visible light communication (S804). The transmitted signal is a signal in which the device discovery signal and the clock signal are encoded by the differential Manchester encoder/decoder. The controller controls the dummy signal comprised of only the clock signal to be transmitted (S806). In this case, the dummy signal is not a signal encoded together with the data signal but a reference clock signal generated in the CDR circuit provided in a transceiver. Thus, since the frequency of the dummy signal is different from that of the signal in which the data signal and the clock signal are encoded, the visible light is not bright as indicated by the reference numeral 710 of FIG. 7. Due to the transmission of the dummy signal, the emission of the visible light is visually identified so that the user can easily align his/her mobile terminal with the receiving terminal 302. The controller checks whether a response signal for the device discovery signal is received from the receiving terminal 302 (S808). If a response signal for the device discovery signal is received, the controller performs step (S810), and if a response signal for the device discovery signal is not received, the controller performs step (S804) again and transmits the device discovery signal at a period of transmitting the device discovery signal.

The controller controls the clock signal of the receiving terminal 302 to be synchronized with the clock signal of the sending terminal 301 by the CDR circuit of the optical transceiver 311 using the device discovery response signal received from the receiving terminal 302 (5810). Since the synchronization of the clock is performed in step (S810), the clock of the sending terminal 301 is already synchronized with the clock of the receiving terminal 302. The is controller controls the optical transceiver to transmit the dummy signal (S812). As such, the dummy signal is continuously transmitted to guide the user to maintain the alignment of the sending terminal with the receiving terminal. In this case, the transmitting dummy signal is not a signal with a duty cycle of ¼ or 3/16, but a signal with a duty cycle of ½ like the signal 618 of FIG. 6A. The controller transmits a link negotiation signal to the receiving terminal 302 for the link connection with the receiving terminal 302 (S814). The controller checks whether a response signal for the link negotiation signal is received from the receiving terminal 302 (S816). If the link negotiation response signal is received, the controller proceeds to step (S818), and if the link negotiation response signal is not received, the controller returns to step (S812) to transmit the dummy signal at the alignment state.

In step (S816), the controller performs the link negotiation by the IrLAP or other protocols during receipt of the link negotiation response signal. If the receiving terminal 302 is linked, the controller transmits data to the receiving terminal 302 in step (S818). In this case, the transmitting data is a signal in which the data signal and the clock signal are encoded by the differential Manchester encoder/decoder. Since a frequency of the encoded signal to be transmitted is different from the frequency of the clock signal, the brightness of the visible light increases. In other words, since a bright visible light is emitted as indicated by the reference numeral 720 of FIG. 7, the user can easily identify the mobile terminals being in communication with each other. The controller checks whether a response signal for the transmitted data is received from the receiving terminal 302 (S820). If a response signal for the transmitted data is received, the controller performs step (S822) to check whether the transmission of the data is finished, and if a response signal for the transmitted data is not received, the controller proceeds to step (S826). If the controller completes checking of the data transmission in step (S822), the controller transmits an end signal to the receiving terminal (S824). If the controller does not complete checking of the data transmission in step (S822), the controller performs step (S818) to transmit the data.

In step (S826), the controller considers the link to be interrupted because the response signal for the transmitted data is not received and transmits the link restoration signal. The controller transmits the dummy signal (S528). Since the transmitted dummy signal is an unsynchronized signal comprising only the clock signal, the transmitted dummy signal has a duty cycle of ¼ or 3/16. The controller checks whether a response signal for the transmitted link restoration signal is received from the receiving terminal 302 (S830). If the response signal is received, the controller controls the clock to be synchronized by the CDR circuit of the optical transceiver as the case of step (S810) through the clock signal contained in the response signal, and performs step (S818) to transmit the data for a part of which the connection was interrupted, again. If the response signal is not received, the controller checks the transmission period of the link restoration signal and transmits the link restoration signal at the transmission period.

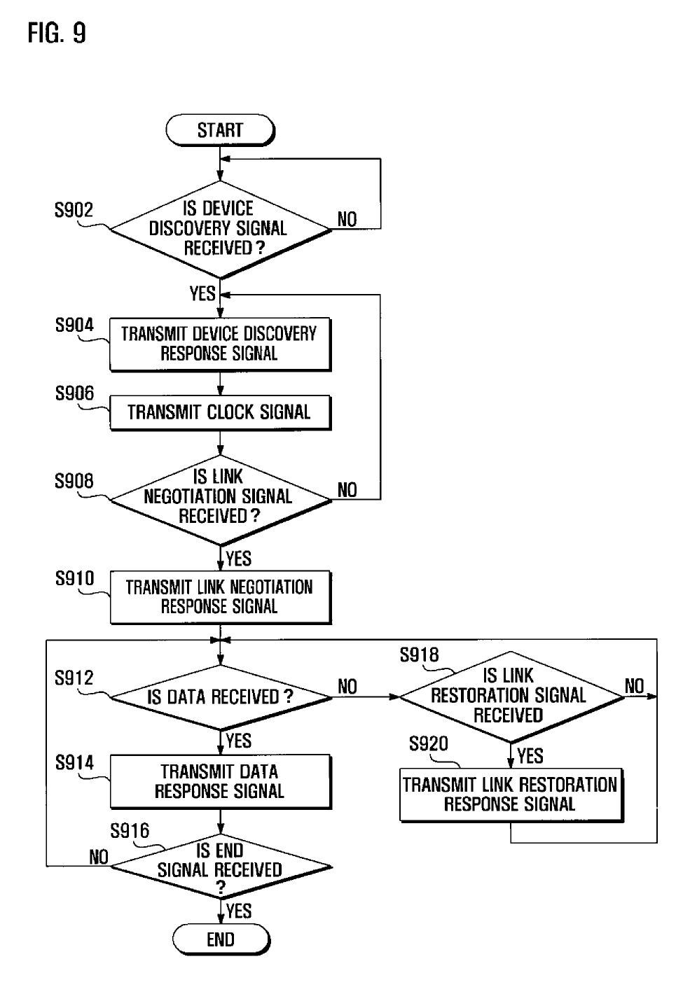

FIG. 9 is a flowchart illustrating the communication performed by the receiving terminal through the visible light, according to an exemplary embodiment of the present invention.

Referring to FIG. 9, a controller (not shown) of the receiving terminal 302 in FIG. 3 checks whether the device discovery signal for the visible light communication is received (S902). The controller controls overall operations of the mobile terminal and overall procedures of the visible light communication carried out through the layers shown in FIG. 3 are performed by the controller. When the device discovery signal is received, the controller transmits a response signal for the device discovery signal to the sending terminal 301 (S904). In this case, the response signal is a signal in which a signal representing the response and a clock signal are encoded by the differential Manchester encoder/decoder. The controller controls the optical transceiver to transmit the clock signal such that the sending terminal 301 can synchronize the clock (S906). The receiving terminal 302 continues the transmission of the clock signal until the communication with the sending terminal 301 is finished. The controller checks whether a link negotiation signal is received from the sending terminal 301 (S908). If a link negotiation signal is received, the controller proceeds to step (S910), and if a link negotiation signal is not received, the controller proceeds to step (S906) to transmit the clock signal. When the link negotiation signal is received, the controller transmits the link negotiation response signal and performs the link negotiation with the sending terminal 301 (S910). After the receiving terminal 302 is connected to the sending terminal through the link negotiation, the controller checks whether data is received from the sending terminal 301 (S912). If the data is received at step (S912), the controller proceeds to step (S914), and if the data is not received, the controller proceeds to step (S918). The controller transmits a response signal for the received data to the sending terminal 301 (S914). The controller checks whether an end signal representing an end of data transmission is received from the sending terminal (S916). If the end signal is received, the communication ends, and if the end signal is not received, the controller proceeds to step (S912) to check whether the data is received. In step (S918), the controller checks whether the link restoration signal is received from the sending terminal 301. If the link restoration signal is received, the controller proceeds to step (S920), and, if the link restoration signal is not received, the controller proceeds to step (S912) to check whether the data is received. The controller transmits a response signal for the received link restoration signal to the sending terminal 301 and returns to step (S912) to check whether the data is received from the sending terminal 301 (S920).

According to the visible light communication of the present invention, light visually identified by a user is emitted so that mobile terminals can be easily aligned with each other and the alignment and the misalignment of the mobile terminals can be easily identified.

As apparent from the above description, a visible light LED is used in the peripheral interface communication so that a user can easily identify the communication path with a naked eye and an excellent communication security can be provided. Moreover, since the communication path is easily aligned, a beam divergence angle can be reduced in comparison to the existing infrared ray communication so that a high speed communication and a low-power communication can be achieved. Since the clock which is used as the dummy signal in the present invention is used as a clock generated in the clock data restoration (CDR) circuit, there is no need for providing a clock generator for generating the dummy signal. The dummy signal transmitted before the synchronization after the device discovery has a short clock duration, the visible light is not bright and has an intensity satisfying appropriate eye safety regulations. As apparent from the above description, when two mobile terminals are aligned with each other, one of them is automatically synchronized with a clock of the other mobile terminal and a pulse duration extends so that there is no need for an alignment indication in a protocol. In the present invention, a guiding beam of the visible light communication is emitted as a dummy signal differently from the infrared ray communication. When the mobile terminals are linked to each other and a channel is established, since the pulse duration is changed to be different from the pulse duration of the dummy signal prior to the synchronization and the brightness of the visible light is also changed, the connection between the two mobile terminals can be visually identified. Moreover, since a ratio of ‘1’ and ‘0’ is maintained during the communication due to the differential Manchester encoder/decoder, the brightness of the visible light can be maintained as uniform.

While exemplary embodiments of the present invention have been shown and described in this specification, it will be understood by those skilled in the art that various changes or modifications of the embodiments are possible without departing from the spirit and scope of the invention as defined by the appended claims.

What is claimed is:

1. A wireless optical communication method comprising:
periodically transmitting device discovery signals for searching for a visible light communication device when there is a request for a visible light communication;
transmitting only reference clock signals between the device discovery signals; and
connecting a link to a receiving terminal to transmit a data when a response signal for the device discovery signal is received from the receiving terminal.

2. The wireless optical communication method of claim 1, wherein a light source used in the visible light communication device comprises a light emitting diode (LED).

3. The wireless optical communication method of claim 2, wherein the device discovery signal and the data are signals with which a clock signal is combined.

4. The wireless optical communication method of claim 3, wherein the device discovery signal is a signal in which a data signal representing a device discovery and the clock signal are encoded by a differential Manchester encoding.

5. The wireless optical communication method of claim 3, wherein the data is a signal in which a data signal and the clock signal are encoded by a differential Manchester encoding.

6. The wireless optical communication method of claim 3, wherein the device discovery signal and the data are signals with a same frequency different from a frequency of a reference clock signal.

7. The wireless optical communication method of claim 6, wherein a brightness and a color of a light source are changed according to the frequency of the data signal and the frequency of the reference clock signal.

8. The wireless optical communication method of claim 1, further comprising:
after the response signal for the device discovery signal is received from the receiving terminal,
synchronizing a clock with a clock of the receiving terminal; and
performing a link negotiation for a link connection.

9. The wireless optical communication method of claim 8, further comprising, after synchronizing of the clock, transmitting only the reference clock signal by changing a duty cycle every preset time until the visible light communication with the receiving terminal is finished.

10. The wireless optical communication method of claim 1, further comprising:
after transmitting of the data to the receiving terminal,
periodically transmitting link restoration signals when the response signal is not received from the receiving terminal;
transmitting only the reference clock signal between the link restoration signals; and
re-connecting the link to the receiving terminal to transmit the data when a response signal from the link restoration signals is received from the receiving terminal.

11. The wireless optical communication method of claim 10, wherein the link restoration signals and the data are signals with a same frequency different from that of the reference clock signal.

12. The wireless optical communication method of claim 11, wherein a brightness and a color of the light source are changed according to the frequency of the data signals and the frequency of the reference clock signal.

13. A wireless optical communication method comprising:
transmitting a response signal to a device discovery signal of searching for a visible light communication device when the device discovery signal of searching for a visible light communication device is received;
transmitting a clock signal; and
receiving data by connecting a link to a sending terminal.

14. The wireless optical communication method of claim 13, wherein the response signal is a signal with which the clock signal is combined.

15. The wireless optical communication method of claim 14, wherein the response signal is a signal in which a data signal representing a response and the clock signal are encoded by a differential Manchester encoding.

16. A mobile terminal comprising:
an optical transceiver to transmit and receive a signal through a visible light;
an encoder/decoder to encode and decode a data signal and a clock signal with differential Manchester codes; and
a controller to periodically transmit device discovery signals of searching for a visible light communication device and to transmit only a reference clock signal between the device discovery signals when a visible light communication is requested, and to connect a link to a receiving terminal to transmit data when a response signal for the device discovery signals is received from the receiving terminal.

17. The mobile terminal of claim 16, wherein a light source of the visible light comprises a light emitting diode (LED).

18. The mobile terminal of claim 17, wherein the optical transceiver comprises a clock data recovery (CDR) circuit to generate the reference clock signal.

19. The mobile terminal of claim 18, wherein the device discovery signals and the data signals are signals with a same frequency different from a frequency of the reference clock signal.

20. The mobile terminal of claim 19, wherein a brightness and a color of the light source are changed according to the frequency of the data signals and the frequency of the reference clock signal.

21. The mobile terminal of claim 16, wherein the controller, after the response signal for the device discovery signals is received from the receiving terminal, synchronizes clock signals with the receiving terminal and performs a link negotiation for the link connection.

22. The mobile terminal of claim 21, wherein the controller, after the synchronization of the clock signals, changes a duty cycle of only the reference clock signal to be transmitted every preset time until the communication with the receiving terminal is finished.

23. The mobile terminal of claim 16, wherein the controller periodically transmits link restoration signals and transmits only the reference clock signal therebetween when a response is not received from the receiving terminal after the transmission of data to the receiving terminal, and re-connects the link to the receiving terminal to transmit the data when a response signal for the link restoration signals is received from the receiving terminal.

24. The mobile terminal of claim 23, wherein the link restoration signals and the data are signals with a same frequency different from a frequency of the reference clock signal.

25. The mobile terminal of claim 24, wherein brightness and a color of a light source are changed according to the frequency of the data signals and the frequency of the reference clock signal.

26. A mobile terminal comprising:
an optical transceiver to transmit and receive a signal through visible light;
an encoder/decoder to encode and decode a data signal and a clock signal with differential Manchester codes; and
a controller to periodically transmit device discovery signals of searching for a visible light communication device and when the device discovery signals are received, to transmit a response signal for the device discovery signals in the form of a signal encoded with the differential Manchester codes, to periodically transmit the clock signal, and to receive data by connecting a link to a sending terminal.

27. The mobile terminal of claim 26, wherein a frequency of the encoded signal is different from that of the clock signal and brightness or a color of a light Source is changed due to the frequency.
